(19) United States
(12) Patent Application Publication
(10) Pub. No.: US 2007/0215160 A1
(43) Pub. Date: Sep. 20, 2007

(54) Protective device

(76) Inventor: Lasse Viljanen, Turku (FI)

Correspondence Address: YOUNG & THOMPSON, 745 SOUTH 23RD STREET, 2ND FLOOR, ARLINGTON, VA, 22202, US

(21) Appl. No.: 11/706,290

(22) Filed: Feb. 15, 2007

(30) Foreign Application Priority Data
Feb. 17, 2006 (FI) 20065120

(51) Int. Cl. A62B 23/02; A62B 7/10; A62B 18/08

(52) U.S. Cl. 128/206.15; 128/206.12; 128/205.27

(57) ABSTRACT

A protective device, which comprises a mask part that covers the user's mouth and nose and that is provided with an opening at which there is arranged a valve means that allows airflow in the mask part only from inside out to convey exhaled air outside of the mask part. The valve means is formed of a plate-like element that is made of flexible material, covers the opening and is connected to the outer surface of the mask part. The plate-like element is provided with through cuts that are arranged to provide, by the effect of exhalation flow, flap parts that turn outwardly from the mask part. The flap parts are arranged to return, after exhalation, back to a position in which the flap parts press in a sealable manner against one another at the cuts.

The invention relates to a protective device, which comprises a mask part covering the user's mouth and nose and is provided with an opening at which there is arranged a valve means enabling airflow in the mask part only from inside out to convey exhaled air outside of the mask part.

The above protective devices are currently well known in connection with various working phases, in which, due to working conditions, the worker is to be protected against various impurities. Welding operations, grinding operations, various cleaning operations and operations involving various dust-releasing materials may be given as examples of works where these situations arise. In connection with the above operations the working conditions are often difficult and high ambient air temperature as well as gases and impurities in the ambient air in general also cause problems.

Various protective device solutions have been developed over the years for the above-described situations. The solution disclosed in U.S. Pat. No. 6,443,153 may be given as an example of solutions known in the field.

The protective device solutions previously known in the art, for instance those disclosed in U.S. Pat. No. 6,443,153, work well, in principle. Details that pose problems in connection with these solutions include, for instance, intake of inhalation air and discharge of exhaled air. Currently, intake of inhalation air is relatively easily arranged by means of various filter solutions and draft-free feed, for instance. In connection with discharge of exhaled air, it is essential that flow resistance is rendered low, so that air discharge will be comfortable for the user. Current protective devices use one or more valve capsules that are fitted in an opening provided in the mask part. The valve capsule comprises a suitable valve part, for instance a flap valve, which only allows flow in the mask part from inside out. In addition, the capsule comprises a frame part, by means of which the capsule is connected to the mask part. The valve capsule is thus an independent unit, which in some protective devices may be replaced by a new one, when necessary, in other words, the user may buy a new capsule as a spare part and change it in the mask part to replace the old capsule.

A drawback with the above-described capsular exhalation valve is the price that is relatively high. The high price, in turn, makes it difficult to produce protective devices that would be disposable. However, the previously mentioned hard working conditions entail that all use and protection properties of the protective device do not remain good for long, which speaks for disposability. The reason for this is, for instance, that the user sweats, which fouls the protective device, etc. A problem is, however, that the prior art has not achieved a cost level that would have made it advantageous, in practice, to encourage the disposability of the protective device.

The object of the invention is to provide a protective device, by means of which disadvantages of prior art may be eliminated. This is achieved with a protective device according to the invention. The protective device according to the invention is characterized in that a valve means is formed of a plate-like element that is made of flexible material, covers the opening and is connected to the outer surface of the mask part, and that the plate-like element is provided with through cuts that are arranged to provide, by the effect of exhalation flow, flap parts that turn outwardly from the mask part and are arranged to return, after exhalation, back to a position in which the flap parts press in a sealable manner against one another at the cuts.

The primary advantage of the invention is that thereby it is possible to provide an economical, disposable solution whose protective properties are still fully comparable to those of considerably more expensive solutions of the prior art. A further advantage of the invention that it is simple and therefore reliable in use.

In the following the invention will be described in greater detail by means of an exemplary solution presented in the attached drawings, wherein

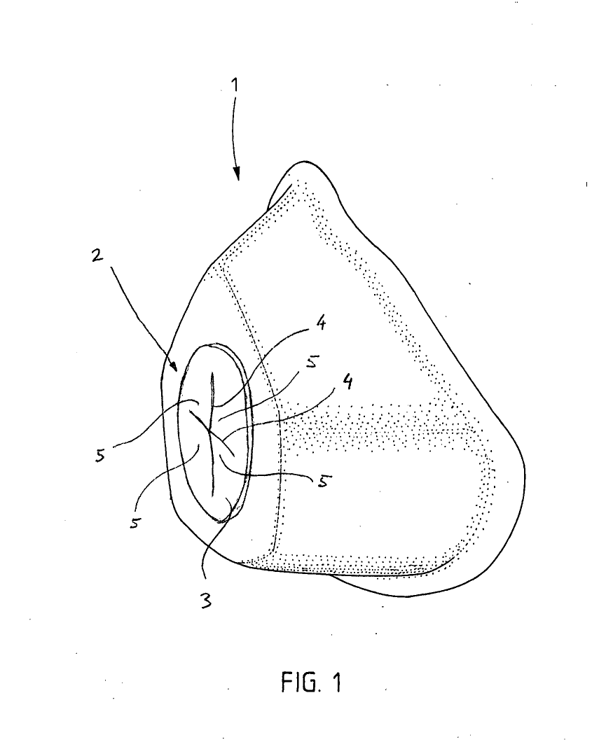

FIG. 1 is a schematic perspective view of a protective device according to the invention;

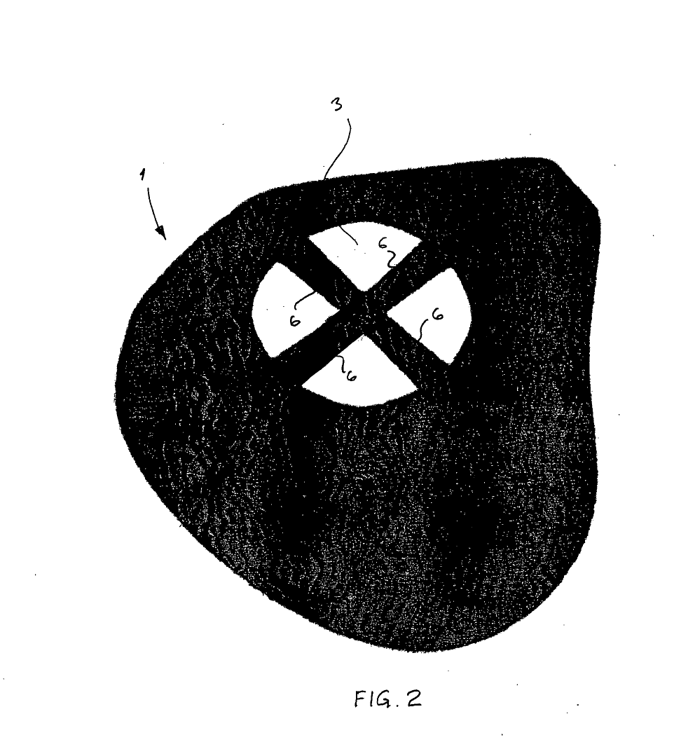

FIG. 2 shows the protective device of FIG. 1 from a different direction, and

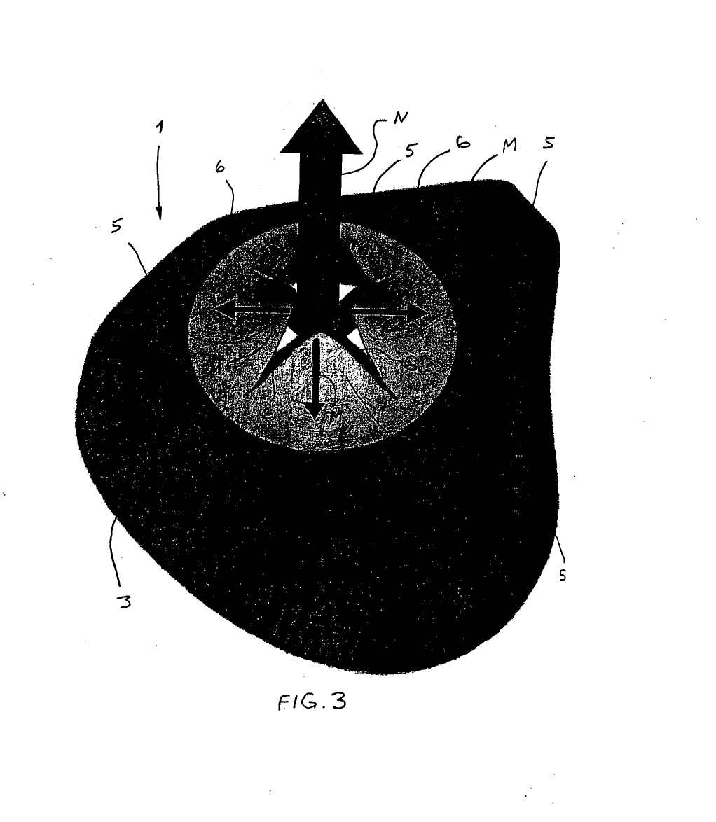

FIG. 3 shows the protective device of FIGS. 1 and 2 in an exhalation situation.

FIG. 1 shows a schematic view of an embodiment of the protective device according to the invention. Reference numeral 1 indicates a mask part covering the user's mouth and nose. Naturally, the mask part 1 also comprises connecting means, by which the mask part may be positioned over the face such that it covers the user's nose and mouth. The above connecting means have not been shown in FIG. 1, because those features are fully conventional technology to a person skilled in the art. In this connection it is mentioned only that the connecting means may be implemented by means of elastic bands, for instance. For the connecting means, in this connection reference is also made to U.S. Pat. No. 6,443,153, in which said detail is described in greater detail.

The mask part 1 is made of a suitable airtight material, such as suitable plastic material.

The mask part 1 is provided with an opening, at which there is arranged a valve means 2 that allows airflow in the mask part only from inside out.

In the mask part 1 it is also possible to arrange second openings, through which inhalation air is conveyed inside the mask part. These openings may be positioned on the sides of the mask part, for instance. Openings for inhalation air have not been presented in FIG. 1, because said features are conventional technology to a person skilled in the art. In this connection, reference is also made to U.S. Pat. No. 6,443,153, which describes feeding of inhalation air inside the mask part in greater detail.

In the following, reference is also made, in addition to FIG. 1, to FIGS. 2 and 3, to describe the basic idea of the invention. FIG. 2 shows the protective device of FIG. 1 seen from a different direction, so that the interior of the mask part is visible. FIG. 3 shows the mask part 1 of the invention in an exhalation situation.

In accordance with the basic idea of the invention the valve means 2 is formed of a plate-like element 3 that is made of flexible material, covers the opening and is connected to the outer surface of the mask part. The plate-like element 3 is provided with through cuts 4 that are arranged to provide flap parts 5 that turn outwardly from the mask part by the effect of exhalation flow. The flap parts 5 bend outwardly in the manner shown in FIG. 3 and return, after exhalation, back to a position shown in FIG. 1, in which the flap parts 5 press in a sealable manner against one another at the cuts 4. Exhalation airflow is indicated schematically by means of arrow N. How the flap parts turn outwardly, by the effect of the exhalation airflow N, is shown schematically in FIG. 3 by means of arrows M.

The plate-like element 3 may be made of any suitable material. Silicone material may be given as an example of suitable material. The thickness of the material for the plate-like element 3 is selected to meet the need, the thickness may be within the range of 1 to 3 mm, for instance.

The plate-like element 3 may be connected to the outer surface of the mask part 1 in any suitable manner, for instance with a suitable adhesive.

By means of the above-described solution it is possible to achieve a valve means that is considerably simpler and less costly than those of the prior art, and at the same time the total price of the protective device will be reduced to a lower level than before. Thus, it is possible to provide a disposable protective device that is useful in practice and that the prior art has not been able to provide. It should be noted that the simple solution of the invention is operationally just as good as those of the prior art.

In the example of the figures, reference numeral 6 denotes support surfaces that are arranged at the cuts 4 formed in the plate-like element 3 in the opening of the mask part. The support surfaces 6 may be provided to be an integral part of the mask part, in other words, the opening may be cut in the mask part such that the opening will have crosswise support surfaces 6 as shown in the figures, for instance. Naturally, the support surfaces 6 may also be formed by arranging suitable, separate support surface elements in the opening provided in the mask part 1.

The support surfaces 6 seal the cut areas, in the situation of FIG. 1, together with the flap parts 5 that press against one another, because in the situation of FIG. 1 the edges of the flap parts 5 press against one another at the cuts 4 and additionally also against the support surfaces 6 as shown in FIG. 2.

In the example of the figures, the cuts 4 are straight cuts and they are arranged to form a cross pattern, which gives four flap parts 5. This is not the only option, however, but in accordance with the basic idea of the invention it is also possible to use other solutions, for instance, more than two straight cuts, i.e. the cuts may produce a star pattern, etc., and various curved cuts are also possible within the scope of the invention.

The plate-like element 3 may be preferably positioned at the intersection of the cuts 4, slightly elevated from the level of support surfaces 6. The above detail appears from FIG. 1, in which the lines depicting the cuts 4 curve upwardly at the intersection of the cuts. The above arrangement enables an advantageous effect, namely, as a pressure difference presses the plate-like element 3 of flexible material against the support surfaces 6, a force is generated that presses the cut surfaces, i.e. the edge surfaces of the cuts, against one another, whereby sealing is secured.

The above embodiment of the invention is by no means intended to restrict the invention, but the invention may be modified fully freely within the scope of the claims. Hence, it is clear that the details of the invention need not necessarily be such as those appearing in the figures but other solutions are also possible.

1. A protective device, which comprises a mask part covering the user's mouth and nose and is provided with an opening at which there is arranged a valve means enabling airflow in the mask part only from inside out to convey exhaled air outside of the mask part, the valve means being formed of a plate-like element that is made of flexible material, covering the opening and being connected to the outer surface of the mask part, and the plate-like element being further provided with through cuts that are arranged to provide, by the effect of exhalation flow, flap parts that turn outwardly from the mask part and are arranged to return, after exhalation, back to a position in which the flap parts press in a sealable manner against one another at the cuts.

2. The protective device of claim 1, wherein the plate-like element is about 1 to 3 mm thick.

3. The protective device of claim 1, wherein the plate-like element is made of silicone material.

4. The protective device of claim 1, wherein in the opening of the mask part, at the cuts provided in the plate-like element, there are arranged support surfaces that are configured to seal the areas of the cuts together with the flap parts that press against one another at the cuts.

5. The protective device of claim 1, wherein the cuts are configured to form a cross pattern.

6. The protective device of claim 4, wherein the plate-like element is configured to be in an elevated position from the level of the support surfaces at the intersection of the cuts.
